(19) United States
(12) Patent Application Publication
(10) Pub. No.: US 2001/0041256 A1
(43) Pub. Date: Nov. 15, 2001

(54) Composite panel

(76) Inventor: Peter F. Heilmayr, Fort Worth, TX (US)

Correspondence Address: Charles D. Gunter, Jr., BRACEWELL & PATTERSON, LLP, 201 Main Street, Suite 1600, Fort Worth, TX, 76102-3105, US

(21) Appl. No.: 09/850,857

(22) Filed: May 8, 2001

Related U.S. Application Data
(63) Continuation-in-part of application No. 09/188,922, filed on Nov. 9, 1998, now abandoned.

(51) Int. Cl. B32B 3/26

(52) U.S. Cl. 428/318.6; 428/319.3

(57) ABSTRACT

A three-layer extrusion of polymer material forming a decorative composite panel, with an outer and inner solid polymer layer of relatively high density, and a central polymer layer of lower density or a filled central polymer layer of higher density. The three layers are coextruded, and each face of the center layer is fused to a respective face of the outer and inner solid polymer layers, forming a solid panel that meets ASTM standards for Rigid Poly(vinyl chloride) Siding. The three layer panel can be coextruded with two extruders (ABA configuration) or three extruders (ABC configuration). The specific layer compositions result in cost savings and material reductions or in performance enhancement of the panel or in providing a higher heat distortion panel or for scrap reclamation.

### CROSS REFERENCE TO RELATED APPLICATIONS

This application is a continuation-in-part of earlier filed Ser. No. 09/188,922, filed Nov. 9, 1998, entitled “Foam Core Composite Panel”, by the same inventor.

### BACKGROUND OF THE INVENTION

1. Field of the Invention

This invention relates generally to panels used as decorative building materials and, more specifically, to such panels which can be used to replace conventional vinyl siding, soffit and skirting of the type used for skirting underneath mobile homes.

2. Description of the Prior Art

There is considerable commercial interest in durable, lightweight building materials which are impact and weather resistant. In particular, paneling for the outside surface of buildings, and for skirting under mobile homes, is important for adding physical protection to the structure and aesthetic appeal. Typical product sold in the marketplace has consisted of paneling that is made up of a single layer of polymer, or a double layer of coextruded polymers. The single and double layer paneling is a rigid polymer extrusion, typically polyvinyl chloride, that contains a variety of additives including pigments for coloration and ultraviolet light absorption.

One of the problems that the present invention seeks to solve is the overall cost of making polymer panels of the above general type. One means for accomplishing this objective is to foam the PVC panel or a layer of the panel. While others have recognized that foaming PVC reduces its cost, previous attempts to manufacture panels with foamed layers have failed to meet minimum impact strength requirements of the industry standard, ASTM Standard D 3679-96.

The present invention, on the other hand, utilizes a third layer of independent composition, non-exposed within the center of the panel that may enhance any of the following desirable features: (1) low cost; (2) high impact strength; (3) higher heat distortion temperature; or (4) scrap reclamation.

One reason the prior art attempts have been unsuccessful has been the failure to properly utilize the “notch sensitive” nature of PVC in regard to the propagation of crack failure. By “notch sensitive” is meant that the energy required to propagate a failure is less than the energy to initiate the failure. Because of this characteristic, the failure mechanism in the prior art panels always begins on the surface of one of the outer layers. In the case of a single layer panel, for example, the single layer would require large concentrations of impact modifying additives dispersed throughout the panel in order to meet the required ASTM Standard. If the outer layer of a two layer panel were impact modified, the failure would similarly be initiated on the side that was not modified with additives and propagate throughout the entire panel. While the concentration of impact modifier could be increased in this manner, this is generally an uneconomic solution to the problem since the impact modifiers add significantly to the overall cost of the formulation.

It is accordingly an object of the present invention to provide a composite panel which provides the impact resistance to meet ASTM Standard D 3679-96 and yet which is more economical to produce than single or double layer panels having increased impact modifiers included in either or both of the single or double layers of the panels.

Another object of the invention is to provide a panel with improved heat distortion characteristics.

Another object of the invention is to provide a panel which allows the use of regrind or other scrap materials in the center layer where the center layer is combined with high-ductility impact modified inner and outer layers.

Another object of the invention is to provide such a panel which is comprised of a plurality of coextruded layers rather than utilizing panel layers which are laminated or glued together.

Another object of the invention is to provide such a coextruded panel which includes a central, less dense foamed layer which is coextruded between rigid PVC inner and outer layers.

Another object of the invention is to provide a decorative composite panel which is durable with respect to environmental exposure, which meets all existing building standards and yet which is less expensive to produce than the prior art materials.

### SUMMARY OF THE INVENTION

This invention is a decorative composite panel which is preferably constructed with an inner, an outer and a center layer. The inner and outer layers are solid polymer layers, typically made of polyvinyl chloride, which have been impact modified so as to constitute high ductility outer layers and can be of identical composition. The center layer is formed from any one of (1) a foamed PVC; (2) a filled PVC; and (3) a foamed and filled PVC. The three layers are coextruded using either two or three extruders, the center layer having opposed exposed faces which are fused during the coextrusion process to the inner and outer layers, respectively.

Preferably, at least the outer layer of solid polymer contains pigment, and its overall specific gravity is between 1.35 and 1.50. The inner layer of solid polymer, whether or not it contains pigment, has the same range in density. The thickness of the inner and outer layers is in a range between 0.004 inches and 0.020 inches.

Where the center layer is foamed, the center layer of foamed polymer will be sandwiched between the outer and inner layers and has certain required characteristics. Specifically, the center layer of foamed polymer has a uniform thickness of between 0.015 inches and 0.040 inches, and a specific gravity ranging from 0.80 to 1.60. This layer is coextruded with the inner and outer layers.

The composite panel as a whole has a thickness between 0.035 inches and 0.060 inches, and will conform to the ASTM standards necessary for Rigid Poly Vinylchloride Siding. In particular, the composite panel is characterized by having an impact resistance of 60 in. lbf, an average heat shrinkage of no more than 3 percent, a uniform gloss across the exposed surface not to vary more than 10 percent, and a minimum windload resistance of 16.3 lbf/ft2 based on ASTM standard methods.

This invention specifically deals with a three layer panel which is extruded and not laminated. The composition may be “A-B-A” or “ABC” accomplished by two or three extruders. Benefits of the invention include one or any combination of (1) cost reduction; (2) material savings; and (3) performance enhancement. The unique three layer structure with each layer having precisely defined design criteria provides the ability to vary the composition of each layer so that performance is concentrated where it is required and, as a result, cost is minimized. The “ABC” configuration of the product also allows further reduction of TiO₂ over conventional one and two layer configurations.

Additional objects, features and advantages will be apparent in the written description which follows.

### BRIEF DESCRIPTION OF THE DRAWINGS

FIG. 1 is a cross sectional view of a panel made according to the teachings of the invention enlarged for ease of illustration.

### DETAILED DESCRIPTION OF THE INVENTION

The purpose of this invention is to create a composite panel that may demonstrate either impact improvement, higher heat distortion temperature or is more economical to manufacture than current panels. The strength of currently made panels is largely dependent upon the density or upon the thickness of the panel. The thicker or more dense the panel, the stronger. The disadvantage in making panels thicker or more dense for strength is in the added cost of materials. Thus, there is a need to create a composite panel that incorporates the characteristics of either enhanced impact resistance, higher heat distortion temperature or lower cost. In Applicant's invention, only specific density ranges in conjunction with specific formulations as herein described provide a panel which will meet the applicable ASTM D-3679-96.

Construction panels should be made so that they can withstand impacts, wind, rain, extremes in temperature, and ultraviolet light. The characteristics of the panel should at least meet the standards defined by the American Society for Testing Materials (ASTM) for Rigid Poly Vinylchloride (PVC) Siding, ASTM Standard D-3679. The panels should maintain a uniform color and be free of any visual surface or structural changes such as peeling, chipping, cracking, flaking or pitting when exposed for long periods of time (years) to temperature ranges from −32° F. to 110° F.

Specifically, the panels should have a minimum thickness of 0.035 inches, a windload resistance of 16.3 lbf/ft², and an impact resistance of 60 in lbf when tested by ASTM standard methods. Other characteristics include an average heat shrinkage of no more than 3 percent, a uniform gloss across the exposed surface not to vary more than 10 percent, and a coefficient of linear expansion not greater than 4.5×10−5 in./in./°F. when tested by ASTM standard methods.

Since the panels are exposed to the exterior of structures, the panels should be able to withstand ultraviolet light. This is accomplished by the addition of pigments such as titanium dioxide (TiO₂). These pigments absorb the ultraviolet light and thus reduce the damage that would otherwise cause the polymers in the panel to deteriorate. However, the addition of pigments such as TiO₂ adds to the cost of the panels.

The objectives discussed above are met in the present invention which provides a lightweight panel that maintains its strength and durability. The composite panels of the present invention embody a unique design for imparting physical strength to the panel while making the panels either lighter or less costly or both. The cost of producing such composite panels is reduced by combining two impact modified outer layers with a foamed, filled or foamed and filled, or higher heat distortion center layer. Where the panel is an ABA or ABC type extrusion, the layers A and C are referred to herein as the “outer layers” with the layers B referred to as the “center layer.”

The objects of the invention are accomplished by making a three-layer coextruded composite panel. By providing impact modified, high ductility outer and inner layers, a choice of any three less expensive composition can be utilized for the center layer. The outer and inner layers will typically be formed of rigid plastic. The outer layer, which would be exposed to the outside of a structure, will typically contain the pigments that absorb ultraviolet light. The inner layer, or the layer that would face the interior of the structure, may contain pigment, depending on whether the extrusion is ABA or ABC composition. Also, the density of the outer and inner layers should be such that the overall strength of the three-layer composite is maintained. The preferred compositions for the outer and inner layers are extruded polymers, most preferably PVC.

The outer and inner layers of the panels of the invention will contain impact modifiers in the range from about 2.0 to 8.0 parts per hundred parts (php), most preferably about 4.0 to 7.5 php. By “impact modifiers” is meant, for example, a traditional acrylic of the type customarily used in the PVC panel industries. Preferred impact modifiers for the exposed layers of the panel include methylmethacrylate and butylacrylate (PMMA grafted onto PBA); ethylenevinylacetate (EVA); and chlorinated polyethylene (CPE). Preferred impact modifiers for the center layer include acrylonitrile butadiene polystyrene (ABS); and methylmethacrylate butadiene polystyrene (MBS) which modifiers are not generally UV resistant.

The center layer of the panel of the invention can be formed of any one or a combination of (1) foamed PVC; (2) filled PVC; (3) foamed and filled PVC; (4) chlorinated PVC; (5) polystyrene-PVC blend; and (6) regrind. The use of impact modifiers is minimized in the center layer and can be omitted entirely. This is accomplished by increasing the concentration of impact modifiers in the inner and outer layers, for example, in the range from about 2.0 to 8.0 php. The center layer is thus characterized by the substantial absence of impact modifiers. By “substantial absence” is meant less than about 2.0 php and preferably no impact modifier at all being present. This approach allows the panel design to minimize the strength requirement of the center layer of the panel while still meeting the ASTM Standards. By concentrating the impact modifier in the outer and inner layers of the panel, the composite structure will endure higher impact than a non-modified panel at a fraction of the cost of a panel modified throughout 100% of its thickness.

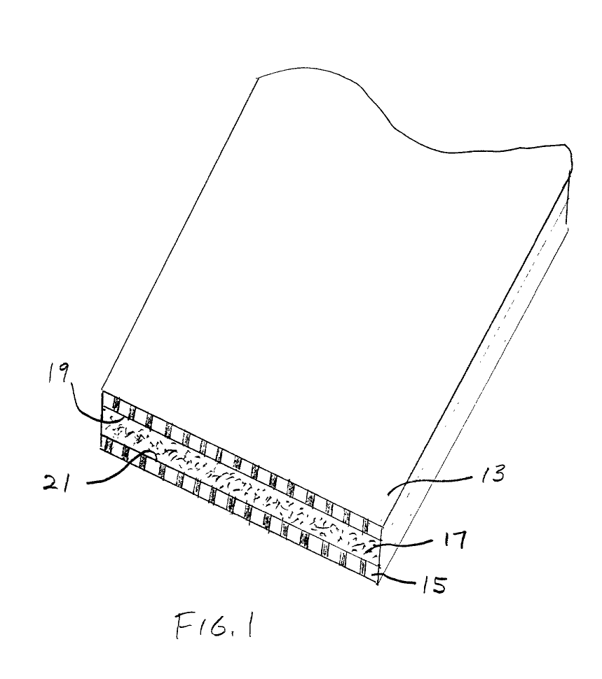

The center layer may be a foamed PVC polymer layer, using foaming techniques that can yield a finer cell structure in the foam layer as well as a higher degree of closed cells that result in acceptable physical properties at lower densities. The center layer imparts lightweight characteristic to the panel, while the outer and inner layers maintain the physical strength of the panel. The panels of the invention have the same appearance and functions current in one and two layer panels but are less expensive to produce. FIG. 1 is a cross-sectional view showing the component layers of the panels of the invention.

Polyvinyl chloride is widely available commercially and produced by well known processes such as suspension polymerization and mass polymerization. Besides PVC other polymers such as AES, ASA, CPE, CPVC, PMMA, PVF, PVDF and PMMA-PBA combinations can be used alone or in conjunction with PVC, particularly for the top layer to improve impact strength and/or weather resistance.

The outer layer 13, formed from one or a combination of the above polymeric materials must also generally contain the color and ultraviolet light-absorbing pigments. This layer is combined by means of the co-extrusion process with the center layer 17 at the interface 19, where one face of the outer layer 13 is extruded to one of the opposing faces of the center layer 17. The outer layer 13 is expected to face the external environment from the structure to which it is attached and thus must be protected from the effects of the external environment. The outer layer has a uniform thickness between 0.004 inches and 0.020 inches, and a specific gravity of between 1.35 to 1.50.

The inner layer 15 is an extruded polymer that may contain pigments in the ABA configuration. The inner layer does not need ultraviolet absorbing pigments such as TiO₂ in the ABC configuration. The inner layer has a uniform thickness between 0.004 inches and 0.020 inches, and a specific gravity of between 1.35 to 1.50.

The center layer 17 may be a foamed polyvinyl chloride layer that is sandwiched between the outer and inner polymer layers. The center layer may be foamed with modified azodicarbonamides during the extrusion process. The central foamed layer has a uniform thickness of between 0.015 inches and 0.040 inches. The specific gravity of a foamed center layer ranges from 0.80 to 1.25. The center layer may also contain a filler or extender such as calcium carbonate to increase the specific gravity thereof.

The inner layer 15 is coextruded to the center layer 17 at the interface 21, where one side of the inner layer is coextruded to the bottom side of the center layer 17. The inner layer 15 is expected to face the interior of the structure to which it is attached. The inner layer, with or without pigment, has a thickness of between 0.004 inches and 0.020 inches, and a specific gravity of between 1.35 and 1.5.

The layers of plastic are coextruded rather than being laminated or glued together. The coextrusion can be accomplished using commercially available multi-manifold dies. The layers are formed together in a molten, liquid state which produces one compact unit of three layers, imparting strength and durability to the composite panel. Those skilled in the art will understand that other similar type devices for co-extrusion could be utilized as well, including either two or three extruder set ups. A three extruder set up would typically be utilized where it is desired to have individual compositions for the separate layers. A three layer panel can also be manufactured using a two extruder set up with one extruder being used to extrude the center layer while the other extruder is used to simultaneously extrude the inner and outer layers. The objectives of the invention can only be met when multi-manifold dies are used which became available in the early 1990's. Older techniques involving flow blocks, e.g., as described in U.S. Pat. No. 4,911,628 (Heilmayr et al.) do not allow the production of layers with tight thickness tolerances as needed for the claimed products. The thickness control of the layers which have materials with dissimilar viscosities, as needed for the claimed products, is only possible with multi-manifold dies.

As has also been mentioned, acrylic polymers can be used to make the outer and inner layers of the panels. Finally, the outer and inner layers can also be made from a mixture of polyvinyl chloride and acrylic.

Calcium carbonates are typically supplied in four forms which are used untreated or treated with stearic acid: water-ground, dry-ground, ultrafine-ground and precipitated. The center layer of the invention can be filled with 1-40 parts of 1-2 micron water ground and treated CaCO₃.

1. Reduced Cost Triwall Panel:

In one embodiment of the invention, a reduced cost triwall panel is provided which has no impact modifier in the center layer and which has 2-8 parts per hundred parts impact modifier in the outer and inner layers. The impact modifiers in the layer exposed to the elements are methylmethacrylate grafted onto butylacrylate, EVA (ethylenevinylacetate), ASA (acrylonitrile-styrene-acrylate) or chlorinated polyethylene. The inner or outer layer not exposed to the elements can contain the impact modifiers used in the exposed layer or MB S (methylmethacrylate-butadiene-styrene) or ABS (acrylonitrile-butadiene-styrene).

2. High Heat Distortion Triwall Panel:

In another embodiment of the invention, a high heat distortion triwall panel is provided in which a coloring additive is included which gives the panels a darker color than the uncolored panels. The coloring additive can be any of those traditionally used in the plastic and PVC arts including organic pigments such as phthalocyanine, etc. Traditionally, only light colors can be used in conventional PVC panels due to the low heat distortion temperature (169 degrees C) of most state of the art compositions. As darker colors, such as different shades of brown are desirable in addition to the colors listed in ASTM D-3679, the heat distortion temperature needs improvement to avoid heat deformation as darker colors absorb more heat.

In this aspect of the invention, the panels of the invention can also provide improved heat distortion characteristics that allow the use of darker colored panels where esthetics or other considerations require darker panels. The heat distortion characteristics of the panels can be significantly improved if the center layer is modified for a higher glass transition temperature. Such modification can be accomplished, for example, by adding fillers which provide a higher glass transition temperature for the structure. A more effective technique is to use chlorinated PVC or polystyrene but this has traditionally resulted in a brittle structure which would not have met the ASTM Standards discussed above. The three layer structure of the panels of the invention allows the use of ductile outer and inner layers with a stiffer, yet more brittle, center layer. The concentration of the impact modifier in the outer and inner layers is increased in the range up to 7.5 to 8.0 php in order to compensate for the brittleness of the center layer where the panels are modified for improved heat distortion characteristics. Even with the stiffer center layer, the design yields a darker colored panel that is resistant to crack initiation and yet is stiffer than would be possible with the same ductility in a two layer or one layer structure.

The coloring additives in the present invention thus give the panel darker colors than listed in ASTM D-3679 and can only be used without panel deformation problems when materials as described in the instant invention are used to increase the heat distortion temperature. The high heat distortion triwall panel has an increased heat distortion center layer and increased ductility inner and outer layers. By using C-PVC (chlorinated PVC) and/or filler and/or polystyrene and/or ABS in the center layer and combining it with high-ductility impact modified inner and outer layers, a panel is produced which still passes overall impact strength requirements in spite of the reduced ductility and increased glass transition temperature of the center layer.

3. Increased Impact Strength Triwall Panel:

In another embodiment of the invention, an increased impact strength triwall panel is provided which has the same dimensions as the reduced cost triwall panel and the high heat distortion triwall panel but shows a 50% impact strength improvement over ASTM D3679-96, which makes it suitable for use in cold climates. The additional impact strength is obtained by using 2-6 parts per hundred parts of impact modifier and a low glass transition temperature formulation in the center layer and 2-8 parts per hundred parts impact modifier in the outer layers. The impact modifiers used in the center layer and unexposed outer layer (only for ABC configuration, not for ABA) can be of the non-weatherable type (MBS, ABS) which is more cost efficient. In this embodiment of the invention, an increased impact strength triwall panel is provided with three impact modified layers where the weather-exposed layer contains a weatherable impact modifier and the center layer and in the case of ABC configuration, one of the outer layers, contains non-weatherable impact modifiers.

4. The Composite Triwall Panels of 1-3 with Regrind in the Center Layer:

In another embodiment of the invention, ground or pulverized regrind and/or mixtures of such regrind with dry blends and also mixed color regrind can also be used for the center layer whenever this layer is combined with high-ductility outer and inner layers as further described herein. Thus, the center layer can be made from regrind, which may contain PVC, filler, acrylics, ASA, CPVC, ABS, MBS and polystyrene as well as products made from these materials which have different colors. This regrind center layer is coextruded and is combined with impact modified inner and outer layers to produce a product which complies with ASTM-D3679-96.

Table I which follows compares the properties and formulations of three prior art panels (Coex dist 1-3) with three typical panels of the invention (A/B/A 1-3).

TABLE I

| Stand- | 44 nominal | 40 nominal | 36 nominal |
|---|---|---|---|
| ard wt. | 44 lb/sq | 40 lb/sq | 36 lb/sq |
| Coex | .004/.040 | .004/.036 | .004/.032 |
| dist (1) | | | |
| VOL % | 9.1%/90.9% | 10.0%/90.0% | 11.1%/88.9% |
| Coex | .006/.038 | .006/.034 | .006/.030 |
| dist (2) | | | |
| VOL % | 13.6%/86.4% | 15.0%/85.0% | 16.7%/83.3% |
| Coex | .008/.036 | .008/.032 | .008/.028 |
| dist (3) | | | |
| VOL % | 18.2%/81.8% | 20.0%/80.0% | 22.2%/77.8% |
| A/B/A | .004/.036/.004 | .004/.032/.004 | .004/.028/.004 |
| (1) | | | |
| VOL % | 9.1%/81.8%/9.1% | 10.0%/80.0%/10.0% | 11.1%/77.8%/11.1% |
| A/B/A | .006/.032/.006 | .006/.028/.006 | .006/.024/.006 |
| (2) | | | |
| VOL % | 13.6%/72.8%/13.6% | 15.0%/70.0%/15.0% | 16.7%/66.6%/16.7% |
| A/B/A | .008/.028/.008 | .008/.024/.008 | .008/.020/.008 |
| (3) | | | |
| VOL % | 18.2%/63.6%/18.2% | 20.0%/60.0%/20.0% | 22.2%/55.6%/22.2% |

Table II provides details of the components of typical panels and serves as the basis for a price comparison of the typical prior art panels to the panels of the invention. A significant price savings will be apparent from a comparison of the data presented.

TABLE II

| | | | Capstock | | | Substrate | | | Foam | | |
|---|---|---|---|---|---|---|---|---|---|---|---|
| | S/LB | SpG | pph | Cost | Ft³ | pph | Cost | Ft³ | pph | Cost | Ft³ |
| PVC | .30 | 1.40 | 100.00 | 30.00 | 1.1441 | 100.00 | 30.00 | 1.1441 | 100.00 | 30.00 | 1.1441 |
| Stabilizer | 4.50 | 1.00 | 0.50 | 2.25 | 0.0080 | 0.50 | 2.25 | 0.0080 | 0.50 | 2.25 | 0.5080 |
| Calcium | 0.55 | 1.00 | 1.00 | 0.55 | 0.0160 | 1.00 | 0.55 | 0.0160 | 1.00 | 0.55 | 0.0160 |
| Stearate | | | | | | | | | | | |
| Wax | 0.60 | 0.90 | 1.00 | 0.60 | 0.0178 | 1.00 | 0.60 | 0.0178 | 1.00 | 0.60 | 0.0178 |
| OPE | 1.20 | 0.90 | 0.20 | 0.24 | 0.0036 | 0.20 | 0.24 | 0.0036 | 0.20 | 0.24 | 0.0036 |
| ACRYLIC | 1.00 | 1.06 | 4.50 | 4.50 | 0.0680 | 4.50 | 4.50 | 0.0680 | 4.50 | 4.50 | 0.0680 |
| TiO₂ | 1.00 | 4.10 | 10.00 | 10.00 | 0.0391 | 1.00 | 1.00 | 0.0039 | 1.00 | 1.00 | 0.0039 |
| CaCo₃ | 0.12 | 2.71 | 0.00 | | | 7.50 | 0.90 | 0.0445 | 5.00 | 0.60 | 0.0296 |
| Cap Color | 2.00 | 2.71 | 1.00 | 2.00 | 0.0118 | 0.00 | | | 0.00 | | |
| Conc. | | | | | | | | | | | |
| Sub Color | 1.00 | 2.71 | 0.00 | | | 1.00 | 1.00 | 0.0012 | 1.00 | 1.00 | 0.0012 |
| BLOWING | 3.00 | 0.00 | 0.00 | | | 0.00 | | | 0.25 | 0.75 | 0.0000 |
| Agent | | | | | | | | | | | |
| ESO | 0.85 | 1.00 | 0.00 | | | 0.00 | | | 1.00 | 0.85 | 0.0160 |
| Totals | | | 118.20 | 50.14 | 1.3084 | 116.70 | 41.04 | 1.3179 | 114.40 | 42.34 | 1.3082 |
| Cost/Ft³ | | | | 38.3216 | | | 31.1405 | | | 32.3651 | |
| Specific | | | | 1.4471 | | | 1.4184 | | | 1.4007 | |
| Gravity | | | | | | | | | | | |

A volume cost calculation can be performed as follows:

BASIC VOLUME COST/SQ

Standard Coex with 0.006 cap, 0.040 nominal.

((0.006/0.040)(38.3216)+(0.034/0.040)(31.1405))(0.45)=$14.4979

NOTE: The base model that is expressed above considers a coex panel with a 0.006 capstock.

This is the minimum capstock coverage that is being produced in the market; however, it is employed for the calculations to give the minimum Coex cost as a comparison.

((0.007/0.040)(38.3216)+(0.033/0.040)(31.1405))(0.45)=$14.5787

The above calculation shows that an additional $0.808/Square would result if the comparison basis was 0.007″ capstock rather than 0.006″.

Foamed a/b/a with 0.006/0.028/0.006 distribution and 1.05 specific gravity foam center.

((0.012/0.040)(38.3216)+(0.028/0.040)(24.2617))(0.45)=$12.8159

NET SAVINGS OF $1.68/Square as compared to 0.006″ cap, $1.76 as compared to 0.007″ cap.

Foamed a/b/a with 0.008/0.024/0.008 distribution and 1.05 specific gravity foam center.

((0.016/0.040)(38.3216)+(0.024/0.040)(24.2617))(0.45)=$13.4485

NET SAVINGS OF $1.05/Square, as compared to 0.006″ cap, $1.13 as compared to 0.007″ cap.

Foamed a/b/a with 0.006/0.028/0.006 distribution and 1.15 specific gravity foam center.

((0.012/0.040)(38.3216)+(0.028/0.040)(26.5723))(0.45)=$13.5437

NET SAVINGS OF $0.95/Square as compared to 0.006″ cap, $1.03 as compared to 0.007″ cap.

Foamed a/b/a with 0.007/0.028/0.007 distribution and 1.10 specific gravity foam center.

((0.014/0.040)(38.3216)+(0.026/0.040)(25.4170))(0.45)=$13.4701

NET SAVINGS OF $1.03/Square as compared to 0.006″ cap, $1.11 as compared to 0.007″ cap.

With a 1.1 specific gravity center layer the weight reduction could be calculated as follows:

as compared to a 0.007″ coex product,

(7/40)(1.4471)(62.43)(0.45)+(33/40(1.4184)(62.43)(0.45)=39.99 lb.

(14/40)(1.4471)(62.43)(0.45)+(26/40)(1.100)(62.43)(0.45)=34.32 lb.

An expected reduction of 5.67 lbs or 14.2%.

The present invention provides several advantages. The composite panels of the invention are an improvement over the current art. The coextruded, three-layer design of the panel in this invention offers panels which exhibit higher impact strength or higher heat distortion resistance or are more economical to produce than the current panels in use. Furthermore, the center layer may decrease the overall cost of the panels since it is of independent composition and does not require high ductility. In fact, the center layer may be of regrind material. Also, having three layers adds versatility to the design, allowing the manufacturer of the panel to either add or not add pigments or other additives to the inner panel, or use different pigments or additives in the inner and outer layers if desired. The design would depend upon the desired use by the customer. In essence, this 3-layer composite structure adds an additional degree of freedom to the selection of the composition of the panel.

A key aspect of the present invention is the provision of solid surfaces on both sides of the foam layer. The solid surfaces contribute to the impact resistance of the final product. Without the solid surfaces on both the outer and inner layers, the foam cell structure would act as an initiation site for impact failure at the point of or directly opposite to the point of impact. The solid-foam-solid structure improves the impact performance beyond what would be possible with either a 100% foam or a solid over foamed two layer sheet. The resultant savings in raw materials would range from 10 to 35% dependent upon the overall thickness of the product, specific thickness of the layers within the range and the specific gravity of the foam within the range defined above.

By distinguishing the unique three ply design, the heat distortion characteristics of the panel can be improved while still providing a panel which has the requisite impact properties under ASTM Standard D-3679.

While the invention has been shown in only four of its forms, it is not thus limited but is susceptible to various changes and modifications without departing from the spirit thereof.

What is claimed is:

1. A composite panel, comprising:
an inner impact modified solid polymer layer and an outer impact modified solid polymer layer, each of said layers having a uniform thickness between 0.004 inches and 0.020 inches, each of said solid polymer layers comprising a polyvinyl chloride polymer formulation with a specific gravity range from 1.35 to 1.50, and wherein each of said inner and outer solid polymer layers contains from 2.0 to 8.0 parts per hundred parts of an impact modifier;
a center layer selected from the group consisting of calcium carbonate filled polyvinyl chloride, foamed polyvinyl chloride, formed and calcium carbonate filled polyvinyl chloride, said center layer being coextruded so as to be fused to said inner and outer solid polymer layers, said center layer having a specific gravity ranging from 0.80 to 1.60 and having thickness ranging from 0.015 inches to 0.040 inches, and wherein said center layer is further characterized by the substantial absence of impact modifier;
said composite panel having a thickness between 0.035 inches and 0.060 inches; and
said composite panel having an impact resistance of 60 in. lbf. as measured in accordance with ASTM Standard D-3679-96.

2. A high heat distortion composite panel, comprising:
high ductility impact modified inner and outer layers formed of solid polyvinyl chloride;
a center layer selected from the group consisting of chlorinated polyvinyl chloride, ABS filled polyvinyl chloride and polystyrene, said center layer having opposed, exposed faces and having a specific gravity ranging from 0.80 to 1.70, and a uniform thickness ranging from 0.015 inches to 0.040 inches, said center layer being sandwiched between and coextruded to the inner and outer coextruded solid polymer layers, whereby said opposed faces of said center layer are fused during the coextrusion process to the inner and outer layers, respectively; and
wherein at least a selected one of the inner and outer layers contain coloring additives which give the panel darker colors than listed in ASTM D-3679, which can only be used without panel deformation problems when the above described materials are used to provide a panel with an increased heat distortion temperature.

3. The composite panel of claim 1, wherein the center layer is comprised of 2 to 6 parts per hundred parts of impact modifier and a low glass transition temperature formulation, wherein the inner and outer layers contain 2 to 8 parts per hundred parts impact modifier and wherein the panel shows a 50% impact strength improvement over ASTM-D3679-96 making it suitable for use in cold climates.

4. The composite panel of claim 1, wherein the center layer is a ground or pulverized regrind material which contains a material selected from the group consisting of PVC, filler, acrylics, ASA, CPVC, ABS, MBS, polystyrene, as well as materials made from these materials which have different colors where the center layer is combined with inner and outer high ductility impact modified layers so that the resultant product complies with ASTM Standard-D-3679-96.

5. A cost efficient triwall panel with adequate strength for siding applications, comprising:
inner and outer layers solid PVC polymer layers having 2 to 8.0 parts per hundred parts impact modifier incorporated therein, wherein the impact modifiers in the layer exposed to the elements are selected from the group consisting of methyhnethacrylate grafted onto butylacrylate, EVA (ethylenevinylacetate), ASA (acrylonitrile-styrene-acrylate) and chlorinated polyethylene, and wherein the inner or outer layer not exposed to the elements contain the impact modifiers used in the exposed layer or MBS (methylmethacrylate-butadiene-styrene) or ABS (acrylonitrile-butadiene-styrene);
a center layer coextruded with said inner and outer layers, the center layer having little or no impact modifier, the center layer being foamed PVC, filled PVC or foamed and filled PVC; and
wherein the triwall panel so constructed provides adequate impact strength for siding, sheet and fence panels by employing impact modifier in the inner and outer layers but is also produced at reduced cost by leaving out any impact modifier in the center layer and using a foamed, filled or foamed and filled center layer rather than employing impact modifier throughout the wall thickness of the panel.

6. A high heat distortion triwall panel which allows the use of darker colors than those called out in ASTM Standard D3679-96 while exhibiting a heat distortion temperature exceeding 169 degrees F., comprising:
inner and outer high-ductility impact modified solid PVC polymer layers having 2 to 7.5 parts per hundred parts impact modifier incorporated therein;
a center layer a center layer selected from the group consisting of chlorinated polyvinyl chloride, ABS filled polyvinyl chloride and polystyrene, said center layer having opposed, exposed faces and having a specific gravity ranging from 0.80 to 1.70, and a uniform thickness ranging from 0.015 inches to 0.040 inches, said center layer being sandwiched between and coextruded to the inner and outer coextruded solid polymer layers, whereby said opposed faces of said center layer are fused during the coextrusion process to the inner and outer layers, respectively;
wherein at least a selected one of the inner and outer layers contain coloring additives which give the panel darker colors than listed in ASTM D-3679, the resulting triwall panel also passing overall impact strength requirements in spite of reduced ductility and increased glass transition temperature of the center layer, which can only be used without panel deformation problems when the above described materials are used.

7. An increased impact strength triwall panel, comprising:
inner and outer layers solid PVC polymer layers having 2 to 8.0 parts per hundred parts impact modifier incorporated therein, wherein the impact modifiers in the layer exposed to the elements are selected from the group consisting of methylmethacrylate grafted onto butylacrylate, EVA (ethylenevinylacetate), ASA (acrylonitrile-styrene-acrylate) and chlorinated polyethylene, and wherein the inner or outer layer not exposed to the elements contain the impact modifiers used in the exposed layer or MBS (methylnethacrylate-butadiene-styrene) or ABS (acrylonitrile-butadiene-styrene);
a center layer coextruded with said inner and outer layers, the center layer having 2 to 6 parts impact modifier and a low glass transition temperature formulation, the impact modifier used in the center layer and unexposed outer layer being of the non-weatherable MBS or ABS type for cost efficiency; and
wherein the triwall panel so constructed exhibits a 50% impact strength improvement over ASTM-D3679-96, making it suitable for use in cold climates.

8. A composite triwall panel having a regrind center layer, comprising:
inner and outer high-ductility impact modified layers of solid PVC polymer having 2 to 8.0 parts per hundred parts impact modifier incorporated therein, wherein the impact modifiers in the layer exposed to the elements are selected from the group consisting of methylmethacrylate grafted onto butylacrylate, EVA (ethylenevinylacetate), ASA (acrylonitrile-styrene-acrylate) and chlorinated polyethylene, and wherein the inner or outer layer not exposed to the elements contain the impact modifiers used in the exposed layer or MBS (methylmethacrylate-butadiene-styrene) or ABS (acrylonitrile-butadiene-styrene);
a coextruded center layer, wherein the center layer is a ground or pulverized regrind material which contains a material selected from the group consisting of PVC, filler, acrylics, ASA, CPVC, ABS, MBS, polystyrene, as well as materials made from these materials which have different colors where the center layer is combined with inner and outer high ductility impact modified layers so that the resultant product complies with ASTM Standard-D-3679-96.
